(19) United States
(12) Patent Application Publication
(10) Pub. No.: US 2003/0168788 A1
(43) Pub. Date: Sep. 11, 2003

(54) Vibrator

(76) Inventor: David Tak-Wei Hon, Shajing Town (CN)

Correspondence Address: SMITH, GAMBRELL & RUSSELL, LLP, 1850 M STREET, N.W., SUITE 800, WASHINGTON, DC, 20036, US

(21) Appl. No.: 10/355,000

(22) Filed: Jan. 31, 2003

(30) Foreign Application Priority Data
Feb. 4, 2002 (CN) 02114811.2

(51) Int. Cl. F16M 1/00

(52) U.S. Cl. 267/136

(57) ABSTRACT

A vibrator comprises at least two leaf springs, both ends of which are connected to a base and a supporting member, one of the two ends of each leaf spring is secured to the base or the supporting member, while the other end is connected by hinge. Said device will make oscillatory vibration when external force is applied to the supporting member. Since one end of the leaf springs is connected by hinge, the vibrator can have larger vibration amplitude and better submission strength.

### FIELD OF THE INVENTION

This invention relates to a vibrator.

### BACKGROUND OF THE INVENTION

A vibrator with resilience is disclosed in China Patent No. 00227772.7, which comprises at least two leaf springs, both ends of which are connected to a base and a supporting member respectively. As shown in FIG. 1 and FIG. 2., when the supporting member makes movements relative to the base under external force, the leaf springs will curve flexibly to change the kinetic energy of the supporting member into potential energy, and then the potential energy is released to push the supporting member to make movements, so as to realize the aim of shock-absorbing or oscillation. In this vibrator, the leaf springs are installed face to face in parallel or non parallel, therefore, during the course of elastic deformation, the two leaf springs will bind to each other to limit the deformation amount, i.e., to limit the vibration amplitude. If the leaf springs used are too short, the rigidity of the vibrator will be too strong, and the amplitude of the possible vibrations will be rather small, so that, when the vibrator is used for shock-absorbing, the shock-absorbing effect will not be satisfactory due to the too small vibration amplitude, and when the vibrator is used for oscillation, the required vibration amplitude may not be obtained. If the leaf springs used are too long, bigger vibration amplitude may be generated, however, the connection rigidity between the supporting member and the base will be too weak, the submission strength of the whole vibrator will be decreased, so that, when the vibrator is used for shock-absorbing, the safety will be too poor. The present invention is an improvement for the above mentioned patent.

### SUMMARY OF THE INVENTION

The aim of this invention is to provide a vibrator which has bigger vibration amplitude without decreasing the submission strength of the base and the supporting member.

A vibrator according to this invention comprises at least two leaf springs, both ends of which are connected to a base and a supporting member respectively, one of the two ends of each leaf spring is secured to the base or the supporting member, while the other end is connected by hinge.

In the vibrator according to this invention, one of the two ends of the leaf springs, by which the leaf springs are connected to the base and the supporting member, is connected by hinge, so that, when the supporting member makes movements, each leaf spring will curve flexibly and bind to each other to limit the elastic deformation amount, in the meanwhile, it is rotatable at the hinge point. Since the other end of the leaf springs is secured, the leaf springs are bound and it is impossible for them to make large angular rotation. That is to say, each leaf spring is bound to each other to limit the elastic deformation, meanwhile, limited minor rotation can be generated at the hinge point to increase the vibration amplitude. Short leaf springs may be used for said vibrator to ensure larger vibration amplitude and better submission strength. Said vibrator is simple in structure, low-cost, and hardly requires any maintenance. It is suitable to be used as mechanical shock-absorbing device, or mechanical vibrator for making oscillatory motions.

### BRIEF DESCRIPTION OF THE DRAWINGS

FIG. 1 and FIG. 2 show prior art shock-absorbing devices;

FIG. 3 and FIG. 4 illustrate the vibrator according to this invention;

FIG. 5 shows the application of this invention where it is used in a kind of optical instrument as a vibrator;

FIG. 6 shows an application of this invention where it is used in bicycles as shock-absorbing device;

FIG. 7 shows another application of this invention where it is used in bicycles as shock-absorbing device;

FIG. 8 shows the prior art device similar to this invention;

FIG. 9 and FIG. 10 show the application of this invention where it is used in buildings as shock-absorbing device.

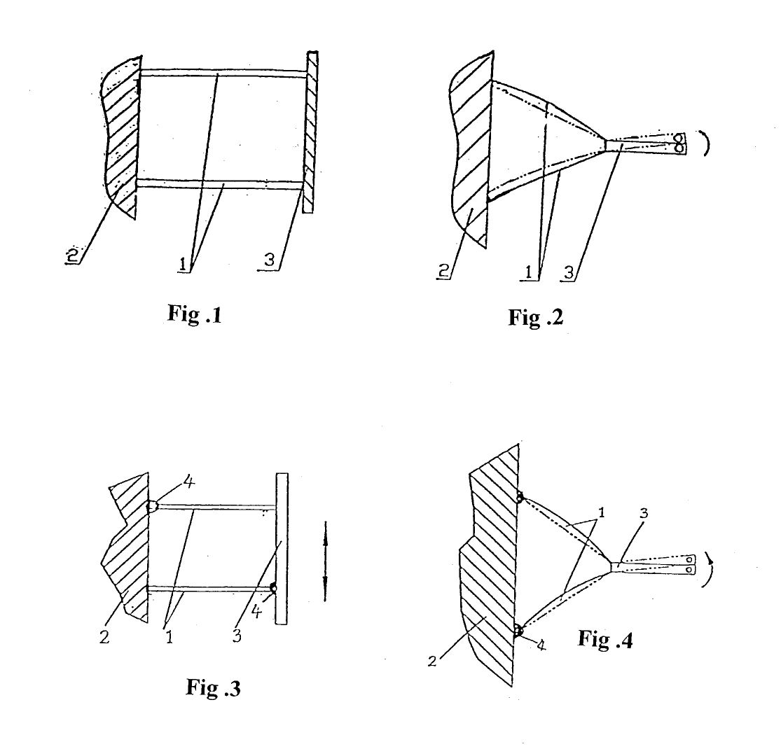

### DETAILED DESCRIPTION OF THE PREFERRED EMBODIMENTS

Embodiment 1:

As shown in FIG. 5, in an optical instrument which can make the reflected light beam vibrating, where the supporting base is defined as the base 2, and the light reflection surface is defined as the supporting member 3, two leaf springs 1 are connected to the base 2 and the supporting member 3 respectively, and one end 4 of the leaf springs is connected by hinge. As long as a constant periodic external force is applied to the base 2 or the supporting member 3, the vibration of the reflection surface will be generated, then the light beam reflected will make vibration in a certain frequency. Since one end of the leaf springs 1 is connected by hinge to the base 2, a vibration with larger amplitude will be generated.

Embodiment 2:

As shown in FIG. 3, the two ends of the two leaf springs 1 are connected to the base 2 and the supporting member 3 respectively, the two leaf springs 1 are installed face to face and in parallel, one of the two ends of the leaf springs 1 is secured to the base 2 and the supporting member 3 respectively, while the other end 4 is connected by hinge. In this case, one of the two leaf springs 1 is hinged to the base 2, while the other is hinged to the supporting member 3, i.e., the hinge ends 4 of the two leaf springs 1 are differently connected.

When external force is applied to the supporting member 3, the leaf springs 1 will curve flexibly and generate minor rotation at the hinge point, the supporting member 3 can make oscillatory vibration relative to the base 2.

Embodiment 3:

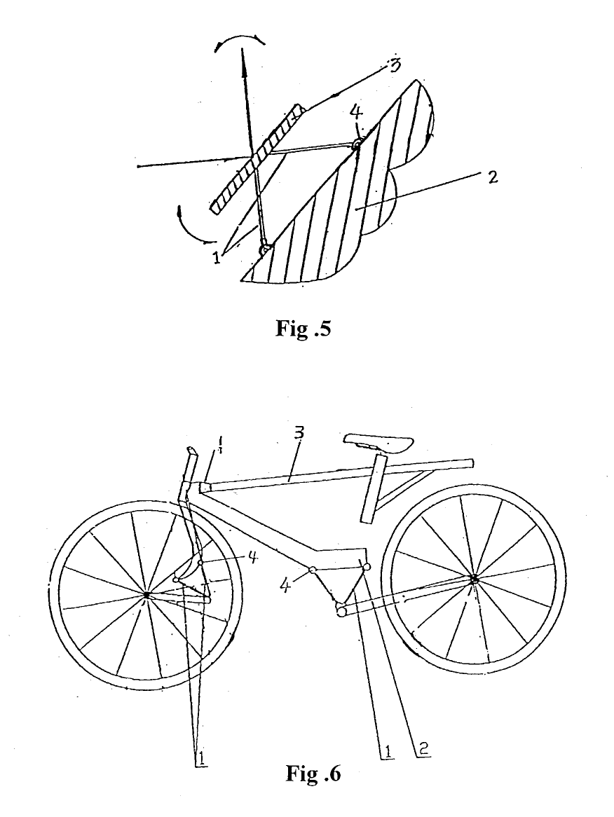

As shown in FIG. 4, the two leaf springs 1 are installed face to face but not in parallel. Seen from the side view, the base 2 and the leaf springs 1 jointly constitute a triangle. Both of the hinge ends of the two leaf springs 1 are hinged to the base 2, i.e., the hinge ends 4 of the two leaf springs 1 are connected to the same object. When external force is applied to the supporting member 3, it will make small angular vibration.

Embodiment 4:

As shown in FIG. 6, said device is used in bicycles as a vibrator. The base 2 and the supporting member 3 are relatively defined. In this embodiment, two leaf springs 1 are hinged to the base 2, the other end of each leaf spring 1 is secured to the supporting member 3 respectively. Actually, the base 2 and the supporting member 3 are interchangeable. Each group of leaf springs 1 are installed face to face but not in parallel. The front fork works as the base 2, the subsidiary fork of the front wheel works as the supporting member 3, the hinge end 4 of the leaf springs 1 is hinged to the front-fork, while the other end secured to the subsidiary fork. The bottom part of the frame works as the base 2, which is hinged to the hinge end 4 of the leaf springs 1, while the leaf springs 1 are secured to the rear fork which is used here as the supporting member 3.

Embodiment 5:

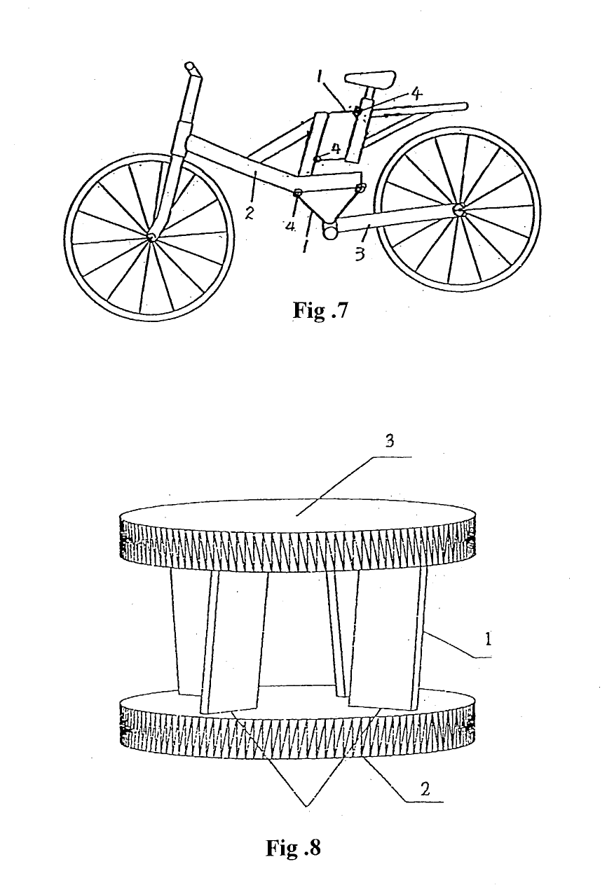

As shown in FIG. 7, two leaf springs 1 are connected to the base 2 and the supporting member 3 in parallel, the two leaf springs 1 are hinged to the base 2 and the supporting member 3 respectively with their different ends. The frame works as the base 2, the post of the cushion works as the supporting member 3, the two ends of the parallel leaf springs 1 are connected to the frame and the post of the cushion respectively. The hinge ends 4 of the two leaf springs 1 are in opposite direction, and are hinged to the base 2 and supporting member 3 respectively. The connection between the frame and the rear fork is the same as that in embodiment 4.

Embodiment 6:

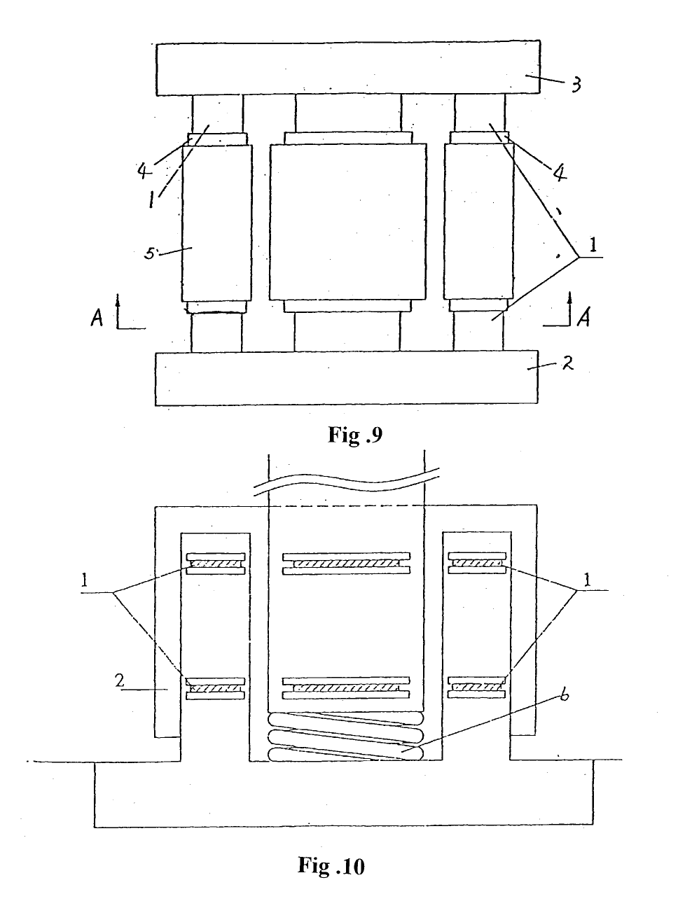

The vibrator according to the prior art is used in buildings as shown in FIG. 8, where its base 2 is connected to the foundation, its supporting member 3 is connected to the building, with several leaf springs 1 connected in between. Since the connection lines between each leaf spring 1 and the base 2 or the supporting member 3 are not in parallel, when they are pressed, the leaf springs 1 will curve and deform simultaneously. If the press and the deformation are too large, the leaf springs 1 may be tom. In this embodiment as shown in FIG. 9 and FIG. 10, several poles 5 are installed between the base 2 and the supporting member 3, both ends of which are hinged to the hinge ends 4 of the leaf springs 1. The leaf springs 1 on the top and the bottom of the poles 5 are secured to the base 2 and the supporting member 3 respectively. The leaf springs 1 connected to the poles 5 are in parallel with each other. FIG. 10 is a cross sectional view of FIG. 9 along A-A line. To limit the vibration amplitude of the supporting member 3, elastic means 6 are installed between the poles 5.

What is claimed is:

1. A vibrator comprises at least two leaf springs (1), both ends of which are connected to a base (2) and a supporting member (3), wherein one of the two ends of each leaf spring (1) is secured to the base (2) or the supporting member (3), while the other end is connected by hinge.

2. A vibrator according to claim 1 wherein the leaf springs (1) are hinged to the base (2) and the supporting member (3) respectively with their different ends.
